(19) United States
(12) Patent Application Publication
(10) Pub. No.: US 2026/0264462 A1
(43) Pub. Date: Sep. 10, 2026

(54) VALVE MOUNTING SYSTEM AND VALVE MOUNTING METHOD

(71) Applicant: CENTRAL MOTOR WHEEL CO., LTD., Anjo-shi (JP)

(72) Inventor: Junji FUNATO, Ama-gun (JP)

(73) Assignee: CENTRAL MOTOR WHEEL CO., LTD., Anjo-shi (JP)

(21) Appl. No.: 19/558,751

(22) Filed: Mar. 6, 2026

(30) Foreign Application Priority Data
Mar. 10, 2025 (JP) 2025-037272

(51) Int. Cl. B60C 25/18

(52) U.S. Cl. CPC B60C 25/185

(57) ABSTRACT

This valve mounting system mounts a snap-in valve into a valve hole provided in a wheel. The system includes: a pulling mechanism that has a grasping tool that grasps a valve leading end portion of the snap-in valve inserted in the valve hole and applies to the grasping tool a pulling force that pulls in a direction of insertion into the valve hole; a pressing mechanism that has a pressing tool that comes into contact with a valve base end portion of the snap-in valve and applies to the pressing tool a pressing force that presses in the direction of insertion; and a controller. The controller maintains a first force at a constant level and increase a second force over time, the first force being one of the pulling force and the pressing force, and the second force being the other.

### CROSS-REFERENCE TO RELATED APPLICATION

This application claims priority to Japanese Patent Application No. 2025-037272 filed on March 10, 2025. The disclosure of the above-identified application, including the specification, drawings, and claims, is incorporated by reference herein in its entirety.

### BACKGROUND

### Technical Field

A technology disclosed in this specification relates to a valve mounting system and a valve mounting method.

### Description of Related Art

There is a known valve mounting system that mounts a snap-in valve having a pneumatic sensor into a valve hole provided in a wheel. This valve mounting system has a force transducer that supports a base end portion of the snap-in valve. The force transducer inserts a valve leading end portion of the snap-in valve into the valve hole and presses the base end portion of the snap-in valve along the direction of insertion into the valve hole (US Patent No. 11472240).

In the above-described valve mounting system, the force for pressing the snap-in valve into the valve hole tends to be insufficient and the posture of the snap-in valve tends to vary in the insertion process. As a result, a problem arises such as that the snap-in valve fails to be normally mounted into the valve hole.

### SUMMARY

The technology disclosed in this specification can be implemented in the following forms.

A valve mounting system according to one aspect of the present disclosure mounts a snap-in valve having a pneumatic sensor into a valve hole provided in a wheel. The valve mounting system includes: a pulling mechanism that has a grasping tool configured to grasp a valve leading end portion of the snap-in valve inserted in the valve hole, and that is configured to apply to the grasping tool a pulling force that pulls in a direction of insertion into the valve hole; a pressing mechanism that has a pressing tool configured to come into contact with a valve base end portion of the snap-in valve, and that is configured to apply to the pressing tool a pressing force that presses in the direction of insertion; and a controller configured to control operations of the pulling mechanism and the pressing mechanism. The controller is configured to maintain a first force at a constant level and increase a second force over time, the first force being one of the pulling force and the pressing force, and the second force being another of the pulling force and the pressing force.

For example, in a configuration in which the pressing force by the pressing mechanism presses the snap-in valve into the valve hole alone, the force for pressing in tends to be insufficient and the posture of the snap-in valve tends to vary in the insertion process. By contrast, in this valve mounting system, the pulling force by the pulling mechanism and the pressing force by the pressing mechanism work together to press the snap-in valve into the valve hole. Thus, this valve mounting system can reduce the likelihood that the force for pressing in may be insufficient and that the posture of the snap-in valve may change in the insertion process. For example, in a configuration in which both the pulling force by the pulling mechanism and the pressing force by the pressing mechanism are changed, management of operation timings of these mechanisms may become complicated. By contrast, in this valve mounting system, the snap-in valve is mounted into the valve hole while the first force that is one of the pulling force by the pulling mechanism and the pressing force by the pressing mechanism is maintained at a constant level and the other second force is increased over time. Thus, in this valve mounting system, management of operation timings of these mechanisms is easy.

The above-described valve mounting system may further include a force sensor configured to output a force detection signal commensurate with a load exerted on the grasping tool of the pulling mechanism, and the controller may be configured to determine that mounting of the snap-in valve is normal in a case where, as an essential condition, a detection result of a variation amount of the load is within a reference variation range based on the force detection signal of the force sensor in a process of application of the first force and the second force. In this valve mounting system, whether the mounting of the snap-in valve has been normal can be determined based on the detection result of the variation amount of the first force between before and after the snap-in valve is pressed into the valve hole.

The above-described valve mounting system may further include a distance sensor configured to output a distance detection signal commensurate with a moving distance of the snap-in valve in the direction of insertion, and the controller may be configured to determine that mounting of the snap-in valve is normal in a case where, as essential conditions, a detection result of the variation amount is within the reference variation range, and moreover a detection result of the moving distance is within a reference distance range based on the distance detection signal of the distance sensor, in the process of application of the first force and the second force. In this valve mounting system, whether the mounting of the snap-in valve has been normal can be more accurately determined based on the detection result of the variation amount of the first force and the detection result of the moving distance.

In the above-described valve mounting system, the pulling mechanism may have a contact tool configured to come into contact with a front surface side of the wheel, and in a process of application of the pulling force, the contact tool may remain in contact with the wheel while the grasping tool may move in the direction of insertion relative to the contact tool. In this valve mounting system, a base point of the pulling force by the pulling mechanism is fixed at the position of contact between the contact tool and the wheel, which stabilizes the pulling force exerted on the snap-in valve.

The technology disclosed by this specification can be implemented in various forms. For example, the technology can be implemented in the forms of a valve mounting system, a valve mounting determination device, a valve mounting method, a valve mounting determination method, a computer program for implementing the functions of such a method or a device, and a non-transitory recording medium that stores that computer program.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is an explanatory view schematically showing the front-side configuration of a steel wheel in an embodiment as seen from outside;

FIG. 2 is an explanatory view showing the configuration of a snap-in valve;

FIG. 3 is an explanatory view showing the configuration of a valve mounting system;

FIG. 4 is an explanatory view showing the snap-in valve in a state before being mounted into a valve hole (pre-mounting state);

FIG. 5 is an explanatory view showing the snap-in valve in a state of having been mounted into the valve hole (mounting-completed state);

FIG. 6 is a flowchart showing the contents of a valve mounting process; and

FIG. 7 is a graph showing variable elements in a mounting step of the snap-in valve.

### DETAILED DESCRIPTION OF EMBODIMENTS

### A Embodiment:

### A 1 Configuration of Vehicular Wheel

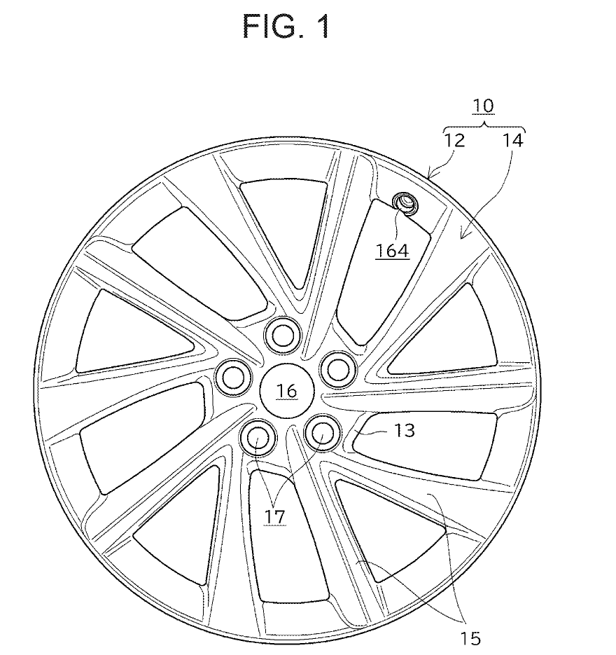

FIG. 1 is an explanatory view schematically showing the front-side configuration of a vehicular wheel (hereinafter referred to as a "wheel") 10 in an embodiment as seen from outside. The wheel 10 includes a substantially cylindrical wheel rim 12, and a substantially disc-shaped wheel disc 14 fitted on an inner circumferential side of the wheel rim 12. Hereinafter, relative to the wheel 10, one side in a wheel axis direction (a front surface side of the wheel 10) will be referred to as an "outer side," and the other side in the wheel axis direction (a back surface side of the wheel 10) will be referred to as an "inner side." When the wheel 10 is fitted on a vehicle main body (not shown), the outer side of the wheel 10 faces the opposite side from the vehicle main body and the inner side of the wheel 10 faces the side of the vehicle main body.

The wheel disc 14 is located on the outer side in the wheel rim 12. The wheel disc 14 includes a hub mounting portion 13 and a plurality of (in this embodiment, 10) spoke portions 15. The hub mounting portion 13 has a substantially disc shape and is located substantially at a center of the wheel disc 14 as seen from the wheel axis direction. A hub hole 16 to which a hub (not shown) of the vehicle main body is coupled is formed substantially at a center of the hub mounting portion 13. A plurality of bolt holes 17 for fixing the wheel 10 to the hub of the vehicle main body is formed around the hub hole 16. The spoke portions 15 are radially disposed between the wheel rim 12 and the hub mounting portion 13.

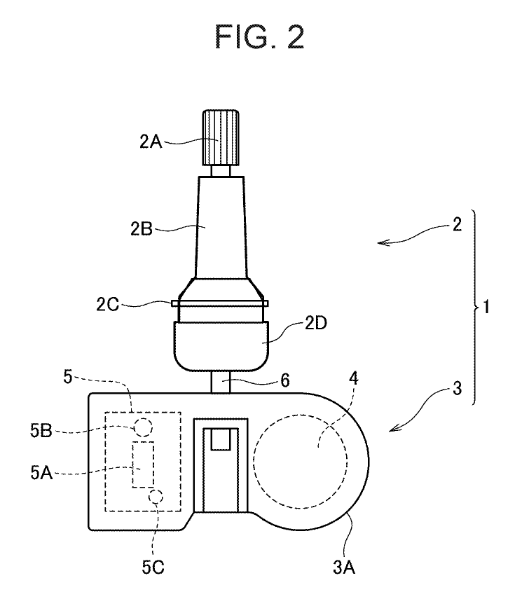

In the wheel 10, a valve hole 164 is provided. The valve hole 164 is a hole for mounting a snap-in valve 1 (see FIG. 2) that serves as a supply port for supplying compressed air into a tire (not shown).

The wheel 10 may be a so-called two-piece type in which the wheel rim 12 and the wheel disc 14 are separate parts, or may be a so-called one-piece type in which the wheel rim 12 and the wheel disc 14 are integrally molded. The wheel 10 may be made of steel or may be made of light alloy, such as aluminum alloy or magnesium alloy.

### A 2 Configuration of Snap-In Valve

FIG. 2 is an explanatory view showing the configuration of the snap-in valve 1. The snap-in valve 1 is an air valve having a sensing function (pneumatic sensor) and is used in, for example, a tire pressure monitoring system. The sensing function is a function of measuring information on an inside of the tire, such as a pressure and a temperature, and transmitting that measurement information to an outside (e.g., a receiver installed inside the vehicle).

The snap-in valve 1 includes a valve main body 2 and a sensing unit 3.

The valve main body 2 has a valve core 6 and a tubular body 2B made of rubber that covers a periphery of an intermediate portion of the valve core 6. A valve cap 2A is fitted on a leading end portion of the valve core 6. A lip 2C is formed on an outer circumference of a base end portion of the tubular body 2B. The lip 2C is an annular portion formed along the entire circumference of the tubular body 2B and protrudes toward a radially outer side of the valve main body 2. A stopper part 2D is provided on the tubular body 2B, on a base end side relative to the lip 2C. The stopper part 2D projects toward the radially outer side of the tubular body 2B.

The sensing unit 3 is coupled to a base end portion of the valve core 6. The sensing unit 3 has a casing 3A, a battery 4, and a sensor circuit board 5. The casing 3A houses the battery 4 and the sensor circuit board 5. The battery 4 is, for example, a disc-shaped button battery. On the sensor circuit board 5, a sensor integrated circuit (IC) 5A, a pneumatic sensor 5B, and an antenna 5C are installed. The pneumatic sensor 5B outputs a detection signal commensurate with a pneumatic pressure inside the tire. The antenna 5C is a communication device that communicates with an external device (not shown). The sensor IC 5A controls the pneumatic sensor 5B and the antenna 5C, and transmits a detection signal from the pneumatic sensor 5B to an external device through the antenna 5C.

### A 3 Configuration of Valve Mounting System

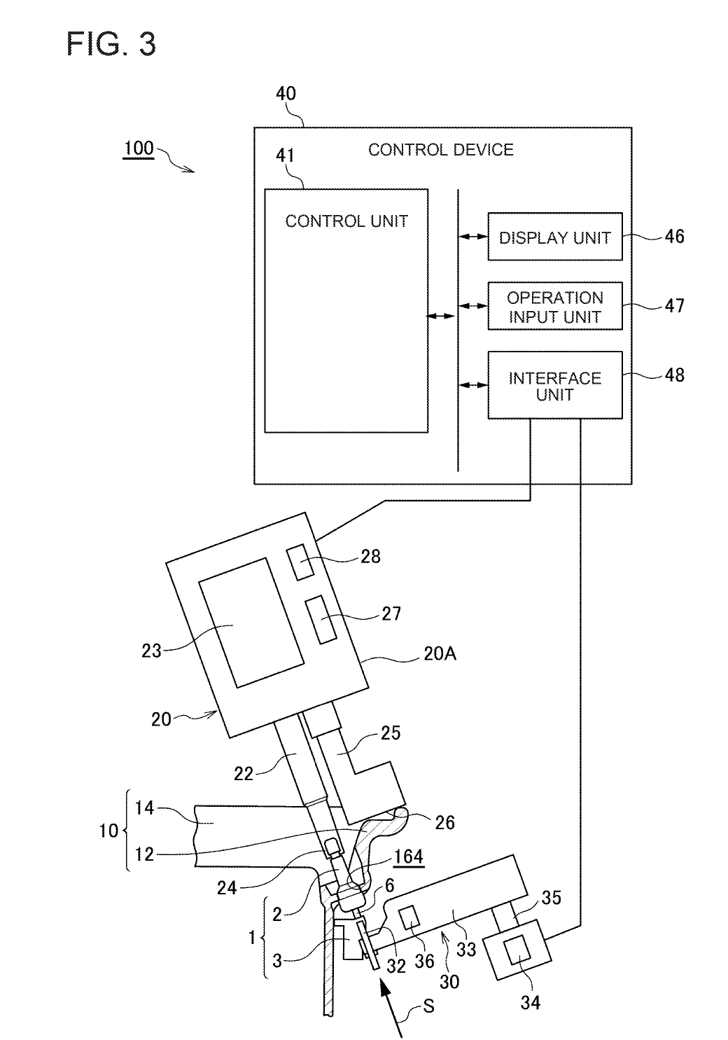

FIG. 3 is an explanatory view showing the configuration of a valve mounting system 100. In FIG. 3, the snap-in valve 1 is in an insertion-completed state to be described later. The valve mounting system 100 is a system for mounting the snap-in valve 1 into the valve hole 164 provided in the wheel 10. The valve mounting system 100 includes a pulling mechanism 20, a pressing mechanism 30, and a control device 40.

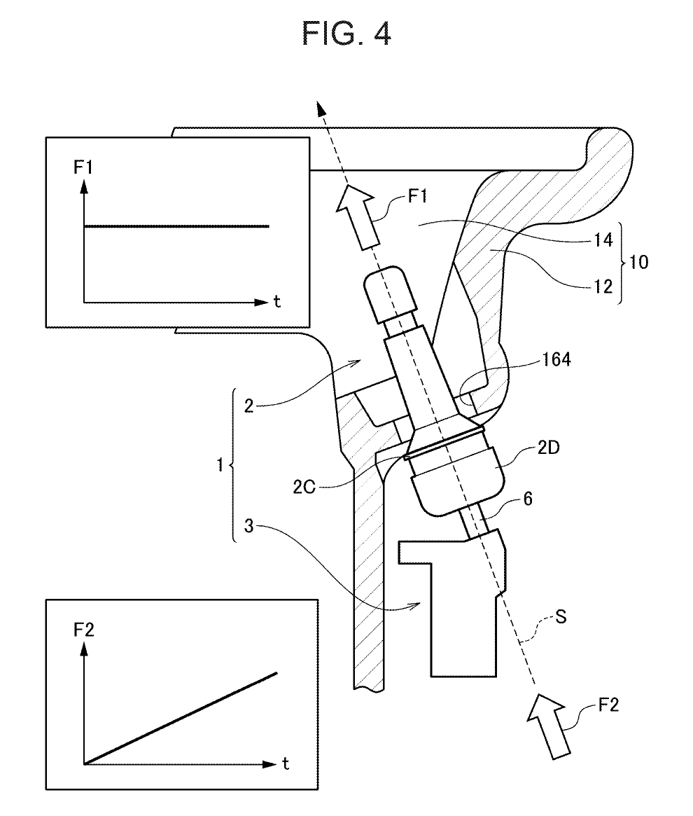

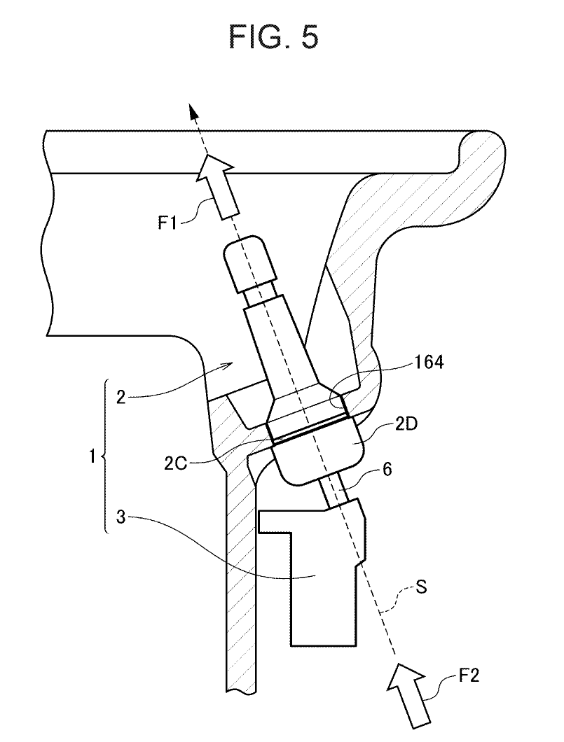

The pulling mechanism 20 has a grasping tool 24 that grasps a valve leading end portion of the snap-in valve 1 inserted in the valve hole 164, and applies to the grasping tool 24 a pulling force F1 (see FIG. 4 and FIG. 5) that pulls along a direction of insertion S into the valve hole 164. The pulling force F1 is a force that pulls along the direction of insertion S from the side of the valve hole 164 toward an inner circumferential side of the wheel rim 12. Specifically, the pulling mechanism 20 is disposed on the inner circumferential side of the wheel rim 12 relative to the wheel 10. The pulling mechanism 20 includes the grasping tool 24, a cylinder 23, a load cell 27, a displacement sensor 28, and a contact tool 25. The pulling force F1 is one example of a first force.

The valve leading end portion of the snap-in valve 1 protrudes toward the inner circumferential side of the wheel rim 12 through the valve hole 164. The grasping tool 24 has a chuck mechanism that grasps the valve leading end portion protruding toward the inner circumferential side of the wheel rim 12. The cylinder 23 has a cylinder rod 22 that moves along the direction of insertion S. The grasping tool 24 is fixed at a leading end portion of the cylinder rod 22. The cylinder 23 may be a pneumatic type or may be a hydraulic type.

The load cell 27 is a force sensor that outputs a force detection signal commensurate with a load F3 (a repulsive force from the snap-in valve 1 against the pulling force F1) exerted on the cylinder rod 22 (grasping tool 24) of the pulling mechanism 20. The displacement sensor 28 is a distance sensor that outputs a distance detection signal commensurate with a moving distance L1 of the cylinder rod 22.

The contact tool 25 extends parallel to the cylinder rod 22 from a casing 20A of the pulling mechanism 20, and a leading end surface 26 of the contact tool 25 is in contact with the front surface side of the wheel 10 (wheel rim 12). Unlike the cylinder rod 22, the contact tool 25 does not move relative to the casing 20A of the pulling mechanism 20, and the distance between the casing 20A and the wheel 10 remains constant.

The pressing mechanism 30 has a pressing tool 32 that comes into contact with the valve base end portion of the snap-in valve 1 (valve core 6), and applies to the pressing tool 32 a pressing force F2 (see FIG. 4 and FIG. 5) that presses along the direction of insertion S. The pressing force F2 is a force oriented from the front surface side of the wheel 10 toward the valve hole 164. Specifically, the pressing mechanism 30 is disposed on an outer circumferential side (well side) of the wheel rim 12 relative to the wheel 10. The pressing mechanism 30 includes the pressing tool 32, a movable arm 33, a cylinder 34, and a proximity sensor 36. The pressing force F2 is one example of the second force.

The valve base end portion of the snap-in valve 1 protrudes toward the outer circumferential side of the wheel rim 12 through the valve hole 164. The pressing tool 32 comes into contact with the valve base end portion of the snap-in valve 1. The cylinder 34 has a cylinder rod 35 that moves along the direction of insertion S. A first end portion of the movable arm 33 is fixed on a leading end portion of the cylinder rod 35. The cylinder 34 may be a pneumatic type or may be a hydraulic type. The pressing tool 32 is fixed on a second end portion of the movable arm 33. The proximity sensor 36 is a magnetic sensor that outputs a detection signal commensurate with a leading end position of the pressing tool 32 (cylinder rod 35).

The control device 40 is a device that acquires detection signals from the respective sensors 27, 28, 36 and controls the pulling mechanism 20 and the pressing mechanism 30. The control device 40 includes a control unit 41, a display unit 46, an operation input unit 47, and an interface unit 48. These units are communicably connected to one another through a bus.

The display unit 46 is formed by, for example, a liquid crystal display or an organic EL display, and displays various images and information. The operation input unit 47 is formed by, for example, a keyboard, a mouse, a button, or a microphone, and accepts manipulations and instructions of a manager. The interface unit 48 is a communication interface that performs communication with other devices by a predetermined communication method through a communication network NET.

The control unit 41 controls the operation of the control device 40. For example, the control unit 41 has a storage function of storing various information, an instruction function of instructing the pulling mechanism 20 and the pressing mechanism 30 on their respective operations, a calculation function of calculating values of variable elements based on detection results from the respective sensors, and a determination function of determining whether there is an abnormal insertion based on the values of the variable elements. These functions of units will be described in conjunction with a description of a valve mounting process to be given later. The control unit 41 may be formed by, for example, a commonly known programmable logic controller (PLC). The control unit 41 is an example of the controller.

### A 4 Valve Mounting Step

FIG. 4 is an explanatory view showing the snap-in valve 1 in a state before being mounted into the valve hole 164 (pre-mounting state), and FIG. 5 is an explanatory view showing the snap-in valve 1 in a state of having been mounted into the valve hole 164 (mounting-completed state). The pre-mounting state is a state where the valve leading end portion that is a leading end side of the snap-in valve 1 from the lip 2C has been inserted into the valve hole 164. In the pre-mounting state, the lip 2C is located in front of the valve hole 164 in the direction of insertion S. The mounting-completed state is a state where the lip 2C has been press-fitted into the valve hole 164 (a post-mounting stopped state to be described later).

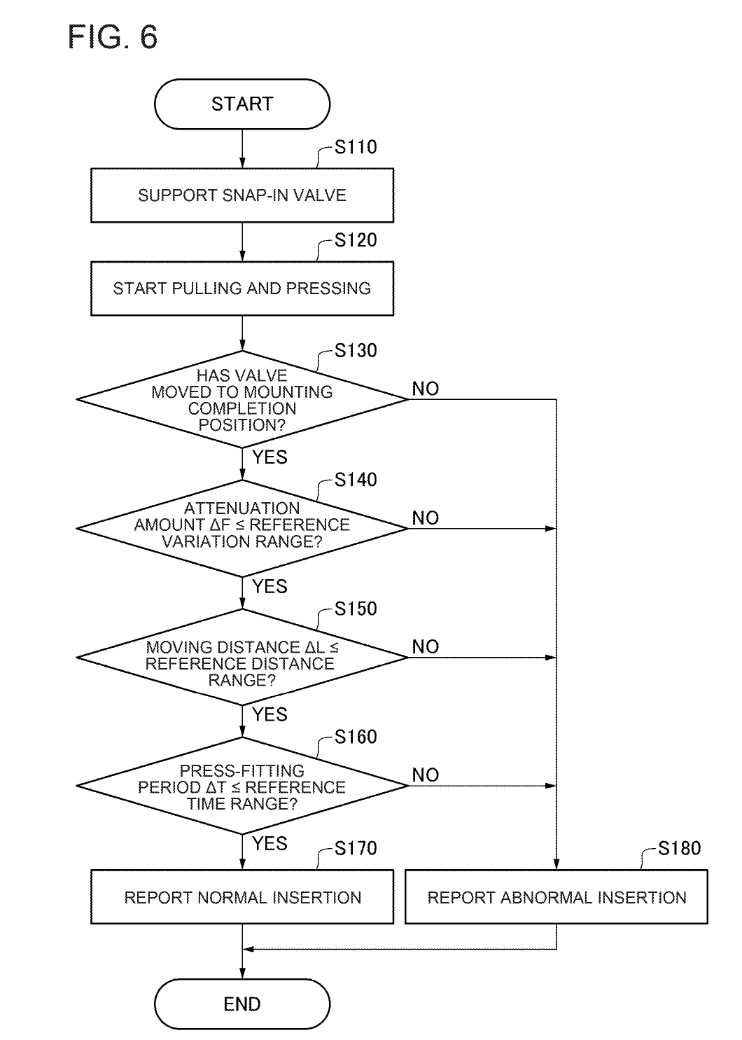

The valve mounting step is a step of bringing the snap-in valve 1 from the pre-mounting state to the mounting-completed state by the valve mounting system 100. When the valve mounting system 100 is activated, the control device 40 executes the valve mounting process shown in FIG. 6.

The control device 40 makes the grasping tool 24 and the pressing tool 32 support the snap-in valve 1 (S110). Specifically, the control device 40 creates a state where the grasping tool 24 of the pulling mechanism 20 is grasping the valve leading end portion of the snap-in valve 1 in the pre-mounting state, and where the pressing tool 32 of the pressing mechanism 30 is in contact with the valve base end portion of the snap-in valve 1 (see FIG. 3 and FIG. 4). At this point, the leading end surface 26 of the contact tool 25 is in contact with the front surface side of the wheel 10 (wheel rim 12) (see FIG. 3).

Next, as shown in FIG. 4, the control device 40 executes control that maintains the pulling force F1 by the pulling mechanism 20 at a constant level and increases the pressing force F2 by the pressing mechanism 30 over time (S120). In other words, in a state where the valve leading end portion of the snap-in valve 1 is pulled by the grasping tool 24 with a constant force, the valve mounting system 100 presses the valve base end portion of the snap-in valve 1 by the pressing tool 32 while increasing the pressing force F2 thereof.

In the processing of S120 (the process of application of the pulling force F1), the contact tool 25 remains in contact with the wheel 10 while the grasping tool 24 moves in the direction of insertion S relative to the contact tool 25. Thus, a base point of the pulling force F1 by the pulling mechanism 20 is fixed at the position of contact between the contact tool 25 and the wheel 10, which stabilizes the pulling force F1 exerted on the snap-in valve 1 at a constant level.

The control device 40 determines whether the snap-in valve 1 has moved to a mounting completion position (S130). The control device 40 detects the leading end position of the pressing tool 32 (cylinder rod 35) based on a detection signal from the proximity sensor 36, and determines whether that detected position has reached a position corresponding to the snap-in valve 1 in the mounting-completed state (see FIG. 5).

When the control device 40 determines that the snap-in valve 1 has not moved to the mounting completion position (S130: NO), the control device 40 determines an abnormal insertion in which the snap-in valve 1 fails to be normally inserted into the valve hole 164, and reports the abnormal insertion (S180) before ending this valve mounting process. An abnormal insertion occurs, for example, when the snap-in valve 1 is pressed into the valve hole 164 in a posture inclined relative to the direction of insertion S for some reason, or when the lip 2C of the snap-in valve 1 fails to be press-fitted into the valve hole 164 due to a defect of the snap-in valve 1 or the wheel 10. Reporting an abnormal insertion includes, for example, displaying information indicating an abnormal insertion on the display unit 46 or notifying an external device, through the interface unit 48, of information indicating an abnormal insertion.

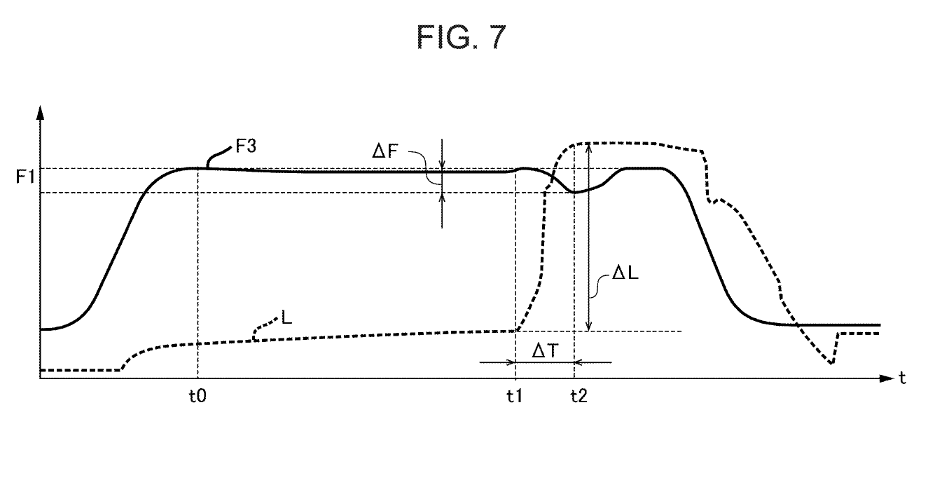

When the control device 40 determines that the snap-in valve 1 has moved to the mounting completion position (S130: YES), the control device 40 more closely determines whether there is an abnormal insertion based on variable elements (behavior) related to the snap-in valve 1 in the process of application of the pulling force F1 and the pressing force F2. FIG. 7 is a graph showing the variable elements in the mounting step of the snap-in valve 1. The axis of abscissas in the graph of FIG. 7 represents a time t that has elapsed from a start point of application of the pulling force F1 and the pressing force F2 (S120). The solid line graph in FIG. 7 represents variations in the load F3 exerted on the cylinder rod 22. In the solid line graph, the axis of ordinates represents the load (N). The broken line graph in FIG. 7 represents variations in the moving distance L1 of the cylinder rod 22. In the broken line graph, the axis of ordinates represents the distance (mm).

As shown in FIG. 7, when the process of application of the pulling force F1 and the pressing force F2 starts, the control device 40 executes control such that the pulling force F1 (e.g., about 200 N to 300 N) by the pulling mechanism 20 remains at a constant level. The pulling force F1 is a force of such a level that it cannot press-fit the lip 2C of the snap-in valve 1 into the valve hole 164 alone in a state where the pressing force F2 by the pressing mechanism 30 is not applied. When the valve leading end portion of the snap-in valve 1 is inserted into the valve hole 164 and the lip 2C comes into contact with a peripheral portion of the valve hole 164, the moving distance L1 of the cylinder rod 22 reaches a predetermined amount (see time t0 to t1 in the broken line graph of FIG. 7). That is, a state is reached where the lip 2C is in contact with the peripheral portion of the valve hole 164 without being press-fitted into the valve hole 164 and movement of the snap-in valve 1 in the direction of insertion S is stopped (hereinafter, this pre-mounting state will be particularly referred to as a "pre-mounting stopped state"). In this pre-mounting stopped state, the load F3 exerted on the cylinder rod 22 has substantially the same value as the pulling force F1 (see time t0 to t1 in the solid line graph of FIG. 7).

On the other hand, the control device 40 increases the pressing force F2 by the pressing mechanism 30. As the pressing force F2 thus increases, the lip 2C of the snap-in valve 1 starts to compressively deform by coming into contact with the peripheral portion of the valve hole 164. As a result, the snap-in valve 1 moves slightly along the direction of insertion S (see time t1 in the broken line graph of FIG. 7). Thereafter, when the pressing force F2 increases further and the lip 2C is compressively deformed to such an extent as to be insertable into the valve hole 164, the lip 2C is pressed into the valve hole 164 at once. As a result, the snap-in valve 1 moves at once along the direction of insertion S, and reaches a state of being stopped at a position where the stopper part 2D hits the peripheral portion of the valve hole 164 (hereinafter, this post-mounting state will be particularly referred to as a "post-mounting stopped state") (see time t2 in the broken line graph of FIG. 7). Hereinafter, a transition period from the pre-mounting stopped state to the post-mounting stopped state (time t1 to t2) will be referred to as a "press-fitting period."

When the lip 2C of the snap-in valve 1 is pressed into the valve hole 164 at once, resistance to press-fitting the lip 2C into the valve hole 164 decreases, so that the load F3 exerted on the cylinder rod 22 attenuates temporarily (see time t1 to t2 in the solid line graph of FIG. 7).

In this embodiment, as the aforementioned variable elements related to the snap-in valve 1, the following elements are handled: an attenuation amount ΔF of the load F3 exerted on the cylinder rod 22 during the press-fitting period, a moving distance ΔL of the cylinder rod 22 during the press-fitting period, and a length ΔT of the press-fitting period.

The control device 40 determines that the mounting of the snap-in valve 1 has been normal when, as an essential condition, a detection result of the attenuation amount ΔF of the load F3 exerted on the cylinder rod 22 is within a reference attenuation range (e.g., 15 N or larger and 100 N or smaller) based on the force detection signal of the load cell 27 in the process of application of the pulling force F1 and the pressing force F2 (S140). Here, that mounting is normal means that the snap-in valve 1 shifts from the pre-mounting state to the mounting-completed state while maintaining a posture along the direction of insertion S. The reference attenuation range is a range having a predetermined width relative to the attenuation amount ΔF in the case where mounting of the snap-in valve 1 has been normal. The reference attenuation range can be specified, for example, by experiments. That is, for a plurality of snap-in valves 1, the attenuation amount ΔF of the load F3 exerted on the cylinder rod 22 when the valve mounting process is executed may be measured, and the reference attenuation range may be specified based on a plurality of measurement results thus obtained. As the reference attenuation range, both an upper limit value and a lower limit value of the attenuation amount ΔF may be specified, or only one of the upper limit value and the lower limit value may be specified. The attenuation amount ΔF is one example of a variation amount and the reference attenuation range is one example of a reference variation range.

When the control device 40 determines that the attenuation amount ΔF of the load F3 is outside the reference attenuation range (S140: NO), the control device 40 detects an abnormal insertion (S180) and ends this valve mounting process. The attenuation amount ΔF of the load F3 can exceed the upper limit value of the reference attenuation range due to, for example, a change in the inclination of the snap-in valve 1 relative to the direction of insertion S. The attenuation amount ΔF of the load F3 can fall below the lower limit value of the reference attenuation range when the outside diameter of the lip 2C of the snap-in valve 1 is relatively small and the resistance to inserting it into the valve hole 164 is small. On the other hand, when the control device 40 determines that the attenuation amount ΔF of the load F3 is within the reference attenuation range (S140: YES), the control device 40 moves to next step S150. That is, in the determination based on the attenuation amount ΔF of the load F3, it is determined that there is no abnormal insertion.

The control device 40 determines that mounting of the snap-in valve 1 has been normal when, as an essential condition, the detection result of the moving distance ΔL of the cylinder rod 22 (snap-in valve 1) during the press-fitting period is within a reference distance range (e.g., 8.5 mm or longer and 12 mm or shorter) based on the distance detection signal of the displacement sensor 28 in the process of application of the pulling force F1 and the pressing force F2 (S150). The reference distance range is a range having a predetermined width relative to the moving distance ΔL of the cylinder rod 22 in the case where mounting of the snap-in valve 1 has been normal. The reference distance range can be specified, for example, by experiments. That is, for a plurality of snap-in valves 1, the moving distance ΔL of the cylinder rod 22 when the valve mounting process is executed may be measured, and the reference distance range may be specified based on a plurality of measurement results thus obtained. As the reference distance range, both an upper limit value and a lower limit value of the moving distance ΔL may be specified, or only one of the upper limit value and the lower limit value may be specified.

When the control device 40 determines that the moving distance ΔL of the cylinder rod 22 is outside the reference distance range (S150: NO), the control device 40 reports an abnormal insertion (S180) and ends this valve mounting process. The moving distance ΔL of the cylinder rod 22 can exceed the upper limit value of the reference distance range due to, for example, a change in the inclination of the snap-in valve 1 relative to the direction of insertion S. The moving distance ΔL of the cylinder rod 22 can fall below the lower limit value of the reference distance range when the outside diameter of the lip 2C of the snap-in valve 1 is relatively small and the resistance to inserting it into the valve hole 164 is small. On the other hand, when the control device 40 determines that the moving distance ΔL of the cylinder rod 22 is within the reference distance range (S150: YES), the control device 40 moves to next step S160. That is, in the determination based on the moving distance ΔL of the cylinder rod 22, it is determined that there is no abnormal insertion.

The control device 40 determines that mounting of the snap-in valve 1 has been normal when, as an essential condition, the measurement result of the length ΔT of the press-fitting period is within a reference time range (e.g., within 13 seconds) based on the detection signal of the proximity sensor 36 in the process of application of the pulling force F1 and the pressing force F2 (S160). The control device 40 can measure the length ΔT of the press-fitting period by starting to count a time from the point when the control device 40 instructs the pulling mechanism 20 and the pressing mechanism 30 on their respective operations, and counting the time that has elapsed before it is detected that the snap-in valve 1 has reached the mounting completion position based on the detection signal of the proximity sensor 36. The reference time range is a range having a predetermined width relative to the length ΔT of the press-fitting period in the case where mounting of the snap-in valve 1 has been normal. The reference time range can be specified, for example, by experiments. That is, for a plurality of snap-in valves 1, the length ΔT of the press-fitting period when the valve mounting process is executed may be measured, and the reference time range may be specified based on a plurality of measurement results thus obtained. As the reference time range, both an upper limit value and a lower limit value of the length ΔT of the press-fitting period may be specified, or only one of the upper limit value and the lower limit value may be specified.

When the control device 40 determines that the length ΔT of the press-fitting period is outside the reference time range (S160: NO), the control device 40 reports an abnormal insertion (S180) and ends this valve mounting process. The length ΔT of the press-fitting period can exceed the upper limit value of the reference time range due to, for example, a change in the inclination of the snap-in valve 1 relative to the direction of insertion S. The length ΔT of the press-fitting period can fall below the lower limit value of the reference time range when the outside diameter of the lip 2C of the snap-in valve 1 is relatively small and the resistance to inserting it into the valve hole 164 is small. On the other hand, when the control device 40 determines that the length ΔT of the press-fitting period is within the reference time range (S160: YES), the control device 40 reports a normal insertion (S170) and ends this valve mounting process. Thus, only when the respective conditions are met (YES) in all the determination processes of S130 to S160, a normal insertion is determined. Reporting a normal insertion includes, for example, displaying information indicating a normal insertion on the display unit 46 or notifying an external device, through the interface unit 48, of information indicating a normal insertion.

### A 5 Advantages of Embodiment

As has been described above, in the valve mounting system 100 of this embodiment, the snap-in valve 1 is mounted into the valve hole 164 while the pulling force F1 by the pulling mechanism 20 is maintained at a constant level and the pressing force F2 by the pressing mechanism 30 is increased over time (see FIG. 3 and FIG. 4).

Here, for example, in a configuration in which the pressing force F2 by the pressing mechanism 30 presses the snap-in valve 1 into the valve hole 164 alone, the force for pressing in tends to be insufficient and the posture of the snap-in valve 1 tends to vary in the insertion process. The rubber tubular body 2B of the snap-in valve 1 is relatively hard, and the strength of the valve cap 2A is low. Therefore, in the configuration in which the pressing force F2 by the pressing mechanism 30 presses in the snap-in valve 1 alone, for example, a force of about 1000 N is applied to the snap-in valve 1, which may lead to breakage etc., of the valve cap 2A. By contrast, in this embodiment, the pulling force F1 by the pulling mechanism 20 and the pressing force F2 by the pressing mechanism 30 work together to press the lip 2C of the snap-in valve 1 into the valve hole 164. Thus, this embodiment can reduce the likelihood that the force for pressing in may be insufficient and that the posture of the snap-in valve may change in the insertion process.

For example, in a configuration in which both the pulling force F1 by the pulling mechanism 20 and the pressing force F2 by the pressing mechanism 30 are changed, management of operation timings of these mechanisms may become complicated. By contrast, in this embodiment, the snap-in valve 1 is mounted into the valve hole 164 while the pulling force F1 by the pulling mechanism 20 is maintained at a constant level and the pressing force F2 by the pressing mechanism 30 is increased over time. Thus, in this embodiment, management of operation timings of these mechanisms is easy.

In this embodiment, it is possible to determine that the mounting is normal when the detection result of the attenuation amount ΔF of F3 (the reaction force from the snap-in valve 1) between before and after the lip 2C of the snap-in valve 1 is pressed into the valve hole 164 is within the reference attenuation range (S140 of FIG. 6).

In this embodiment, even if the attenuation amount ΔF of the load F3 is within the reference attenuation range (S140: YES), when the moving distance ΔL of the cylinder rod 22 (snap-in valve 1) is outside the reference distance range (S150: NO), it is determined that the mounting of the snap-in valve 1 is not normal. Thus, in this embodiment, whether the mounting of the snap-in valve 1 has been normal can be more accurately determined based on the detection result of the attenuation amount ΔF of the load F3 and the detection result of the moving distance ΔL of the cylinder rod 22.

In this embodiment, even if the attenuation amount ΔF of the load F3 is within the reference attenuation range (S140: YES) and moreover the moving distance ΔL of the cylinder rod 22 is within the reference distance range (S150: YES), when it is determined that the length ΔT of the press-fitting period is outside the reference time range (S160: NO), it is determined that the mounting of the snap-in valve 1 is not normal. Thus, in this embodiment, whether the mounting of the snap-in valve 1 has been normal can be more accurately determined based on the detection result of the attenuation amount ΔF of the load F3, the detection result of the moving distance ΔL of the cylinder rod 22, and the detection result of the length ΔT of the press-fitting period.

### B Modified Examples

The technology disclosed in this specification is not limited to the above-described embodiment and can be modified into various forms within a range not departing from the gist thereof. For example, the following modifications are possible.

The configuration of the valve mounting system 100 in the above-described embodiment is merely one example, and various modifications are possible. For example, the valve mounting system 100 may have a configuration that does not include the contact tool 25. The valve mounting system 100 may have a configuration that does not include at least one of the load cell 27, the displacement sensor 28, and the proximity sensor 36. The pulling mechanism 20 is not limited to the cylinder 23, and the pulling force F1 may be generated by another mechanism (e.g., an electric type that uses an electric motor). The pressing mechanism 30 is not limited to the cylinder 34, and the pressing force F2 may be generated by another mechanism (e.g., an electric type that uses an electric motor). In the above-described embodiment, the pulling mechanism 20 and the pressing mechanism 30 may be coupled together by a link mechanism (not shown) such that the pressing force F2 by the pressing mechanism 30 is transmitted to the pulling mechanism 20.

The valve mounting process in the above-described embodiment is merely one example, and various modifications are possible. For example, in S120 of FIG. 6, the control device 40 may execute control that increases the pulling force F1 by the pulling mechanism 20 over time and maintains the pressing force F2 by the pressing mechanism 30 at a constant level. In this case, the pulling force F1 is one example of a second force and the pressing force F2 is one example of the first force. In the above-described embodiment, the order of the determination processes of S140 to S160 among the processes of FIG. 6 can be arbitrarily changed, and the determination processes of S140 to S160 may be concurrently executed. In the above-described embodiment, a configuration may be adopted in which at least one of the determination processes of S130 to S160 among the processes of FIG. 6 is not executed.

In the above-described embodiment, the attenuation amount ΔF of the load F3 exerted on the pulling mechanism 20 (cylinder rod 22) during the press-fitting period has been illustrated as the variation amount. However, the variation amount is not limited thereto and may instead be, for example, the variation amount of the load exerted on the pressing mechanism 30 during the press-fitting period.

What is claimed is:

1. A valve mounting system for mounting a snap-in valve having a pneumatic sensor into a valve hole provided in a wheel, the valve mounting system comprising:
a pulling mechanism that has a grasping tool configured to grasp a valve leading end portion of the snap-in valve inserted in the valve hole, and that is configured to apply to the grasping tool a pulling force that pulls in a direction of insertion into the valve hole;
a pressing mechanism that has a pressing tool configured to come into contact with a valve base end portion of the snap-in valve, and that is configured to apply to the pressing tool a pressing force that presses in the direction of insertion; and
a controller configured to control operations of the pulling mechanism and the pressing mechanism, wherein
the controller is configured to maintain a first force at a constant level and increase a second force over time, the first force being one of the pulling force and the pressing force, and the second force being another of the pulling force and the pressing force.

2. The valve mounting system according to claim 1, further comprising a force sensor configured to output a force detection signal commensurate with a load exerted on the grasping tool of the pulling mechanism, wherein
the controller is configured to determine that mounting of the snap-in valve is normal in a case where, as an essential condition, a detection result of a variation amount of the load is within a reference variation range based on the force detection signal of the force sensor in a process of application of the first force and the second force.

3. The valve mounting system according to claim 2, further comprising a distance sensor configured to output a distance detection signal commensurate with a moving distance of the snap-in valve in the direction of insertion, wherein
the controller is configured to determine that mounting of the snap-in valve is normal in a case where, as essential conditions, a detection result of the variation amount is within the reference variation range, and moreover a detection result of the moving distance is within a reference distance range based on the distance detection signal of the distance sensor, in the process of application of the first force and the second force.

4. The valve mounting system according to claim 1, wherein:
the pulling mechanism has a contact tool configured to come into contact with a front surface side of the wheel; and
in a process of application of the pulling force, the contact tool remains in contact with the wheel while the grasping tool moves in the direction of insertion relative to the contact tool.

5. A valve mounting method for mounting a snap-in valve having a pneumatic sensor into a valve hole provided in a wheel, the valve mounting method comprising:
pulling a valve leading end portion of the snap-in valve inserted in the valve hole with a pulling force oriented in a direction of insertion into the valve hole;
pressing a valve base end portion of the snap-in valve with a pressing force oriented in the direction of insertion; and
maintaining a first force at a constant level and increase a second force over time, the first force being one of the pulling force and the pressing force, and the second force being another of the pulling force and the pressing force.
